(19) United States
(12) Patent Application Publication
(10) Pub. No.: US 2006/0264219 A1
(43) Pub. Date: Nov. 23, 2006

(54) Architecture for integration of application functions within mobile systems

(76) Inventors: Aharon Satt, Haifa (IL); Gennady Sorokopud, Netanya (IL)

Correspondence Address: POLSINELLI SHALTON WELTE SUELTHAUS P.C., 700 W. 47TH STREET, SUITE 1000, KANSAS CITY, MO, 64112-1802, US

(21) Appl. No.: 11/132,077

(22) Filed: May 18, 2005

(51) Int. Cl. H04Q 7/20

(52) U.S. Cl. 455/452.2

(57) ABSTRACT

A network, such as a mobile network, is integrated with at least one application function, providing a mechanism that allows for the exchange of data between the mobile network and the application function. This mechanism is generic and aware of changing radio conditions, such as bandwidth, delay and jitter. It provides the application function with present network conditions, allowing the application function to adjust its level of service.

### TECHNICAL FIELD

The present invention is directed to integration of application functions in mobile networks. In particular, the present invention is directed to packet traffic management architectures that support application functions, and manage packet traffic in accordance with the application function.

### BACKGROUND OF THE INVENTION

Application functions provide services to mobile stations via mobile networks. Some application functions, for example, include servers or application servers, proxy servers, performance enhancement proxies and routers. To enable communication between the mobile user and the application function, the application function needs to receive information about each mobile user and the network conditions they experience. This information typically includes bandwidth, delay and jitter.

Most contemporary application functions operate irrespective of the existing conditions on the mobile network, and additionally, lack the capabilities to signal the mobile network about conditions necessary for suitable operation. Suitable conditions for normal operation of an application function on the mobile network are dependent on the nature of the application function.

As a result of the application function operating irrespective of the mobile network, the application function can not operate under desired conditions. This causes the Quality of Service (QoS) and Quality of Experience (QoE), both user defined parameters, to decrease to a point of user dissatisfaction.

Presently there are not any generic mechanisms that will coordinate operation of application functions with mobile networks. Moreover, there are not any unified mechanisms for the mobile network to publish information about every user and every condition.

An emerging standard ties together application functions and the mobile networks through an interface. However, this emerging standard is extremely limited in that it only permits specific functions, like IMS (Internet Protocol (IP) Multimedia Subsystem). Also, the mechanisms defined in the standard are not aware of radio conditions. Rather, they are dependent on information recorded from the mobile station, as to any policies inside the mobile network.

### SUMMARY OF THE INVENTION

The present invention improves on the contemporary art in that it provides a mechanism to exchange data between the mobile network and the application function (AF). This mechanism is generic and aware of changing radio conditions, such as bandwidth, delay and jitter. It provides the application function with present network conditions, allowing the application function to adjust its level of service. This results in high Quality of Service (QoS) and Quality of Experience (QoE).

The present invention integrates application functions into mobile networks that provide data services to mobile stations. The invention includes a mechanism where policies received by the mobile network from the application function are implemented and enforced by the mobile network, or components of the mobile networks. This enforcement may include, for example, bandwidth allocation, prioritization, flow admission and drop control. For example, these functions can be performed by a traffic shaper, for example, a GPRS Mobile Traffic Shaper™ from Cellglide Ltd. of Israel. This traffic shaper also includes the functionality to collect information regarding the current network conditions from the mobile network.

The present invention provides a mechanism that is flexible as it allows the application function to subscribe for a particular type of information related to the mobile network, or for a particular type of traffic. For example, in case of an application function being a streaming server, the application function may require only information about jitter, delay and bandwidth for currently active streaming subscribers.

Alternately, where the application function includes a web server, this application function may require only bandwidth information about currently active web user. In another example, the Performance Enhancing Proxy optimizing web traffic may signal for a particular type of web traffic in order to achieve optimal performance.

An embodiment of the invention is directed to an architecture or system for supporting at least one application function. The architecture includes a first component for obtaining information on conditions in a mobile network, and a second component for receiving and translating the information on the conditions in the mobile network to data usable by the application function, and sending the information to the application function. There is also a traffic control module configured for controlling traffic to and from the application function, and a Quality of Service (QoS) module configured for receiving QoS policies and enforcing the QoS policies on the traffic to and from the at least one application function. Example application functions may include servers, application servers, proxy servers, web servers, streaming servers, performance enhancement proxies, routers and Push To Talk (PTT) servers. The at least one application function may be a single application function or multiple application functions, typically in groups.

Another embodiment of the invention is directed to a method for managing traffic for at least one application function. The method includes, obtaining information on conditions in a mobile network, translating the obtained information on the conditions in the mobile network to data usable by the at least one application function, sending the translated information to the at least one application function in accordance with at least one predetermined policy, and, controlling traffic to and from the at least one application function. The traffic is controlled by enforcing the at least one predetermined policy on the traffic to and from the at least one application function.

Another embodiment of the invention is directed to an architecture or system for supporting at least one application function. The architecture includes, a first component for obtaining information on conditions in a mobile network, and, a second component for receiving and translating the information on the conditions in the mobile network to data usable by the at least one application function, and sending the information to the at least one application function. There is also a traffic control module configured for controlling traffic to and from the at least one application function, and, there is a subscription module. The subscription module is configured for receiving at least one subscription request from the at least one application function, and translating the at least one subscription request to at least one traffic policy for at least one of: the traffic control module or the second component. Example application functions may include servers, application servers, proxy servers, web servers, streaming servers, performance enhancement proxies, routers and Push To Talk (PTT) servers. The at least one application function may be a single application function or multiple application functions, typically in groups.

Another embodiment of the invention is directed to a method for integrating at least one application function into a mobile network. The method includes, obtaining information on conditions in a mobile network, translating the information on the conditions in a mobile network to data usable by the at least one application function, and sending the information to the at least one application function, controlling traffic to and from the at least one application function, receiving at least one subscription request from the at least one application function, and, translating the at least one subscription request. The at least one subscription request is translated to at least one of: a traffic policy for controlling traffic to and from the at least one application function, or at least one policy for translation of information on conditions in the mobile network.

Another embodiment of the invention is directed to an architecture or system for supporting Push To Talk (PTT) services in a network, for example, a mobile network. The architecture includes a first component configured for controlling PTT traffic, between at least one mobile station and at least one application function, a second component for receiving and translating information on conditions in a network to data usable by the first component, and, a third component. The third component is configured for accommodating bursts corresponding to PTT traffic by temporarily revoking bandwidth from other traffic and admitting the PTT traffic into the network regardless of receiving information on the network conditions. The at least one application function is, for example, at least one Push To Talk (PTT) server.

Another embodiment of the invention is directed to a method for supporting Push To Talk (PTT) services in a network. The method includes, controlling PTT traffic, between at least one mobile station and at least one application function, receiving and translating information on conditions in a network to data usable for control of the PTT traffic, and, accommodating bursts corresponding to the PTT traffic by temporarily revoking bandwidth from other traffic and admitting the PTT traffic into the network. Admitting the PTT traffic into the network typically includes admission regardless of receiving information on conditions of the network.

### BRIEF DESCRIPTION OF THE DRAWINGS

Attention is now directed to the drawing figures, where like reference numerals and or characters indicate corresponding or like components. In the drawings:

FIG. 1 is a schematic diagram for an exemplary architecture in accordance with an embodiment of the invention;

FIG. 2 is a schematic diagram of the integration device and the application function in accordance with an embodiment of the invention;

FIG. 3 is a schematic diagram for an exemplary architecture in accordance with another embodiment of the invention;

FIGS. 4A and 4B are a flow diagram detailing an exemplary process in accordance with an embodiment of the invention; and,

FIG. 5 is a schematic diagram of an exemplary architecture that incorporates a Push To Talk (PTT) application function into a mobile network, in accordance with an embodiment of the invention.

### DETAILED DESCRIPTION

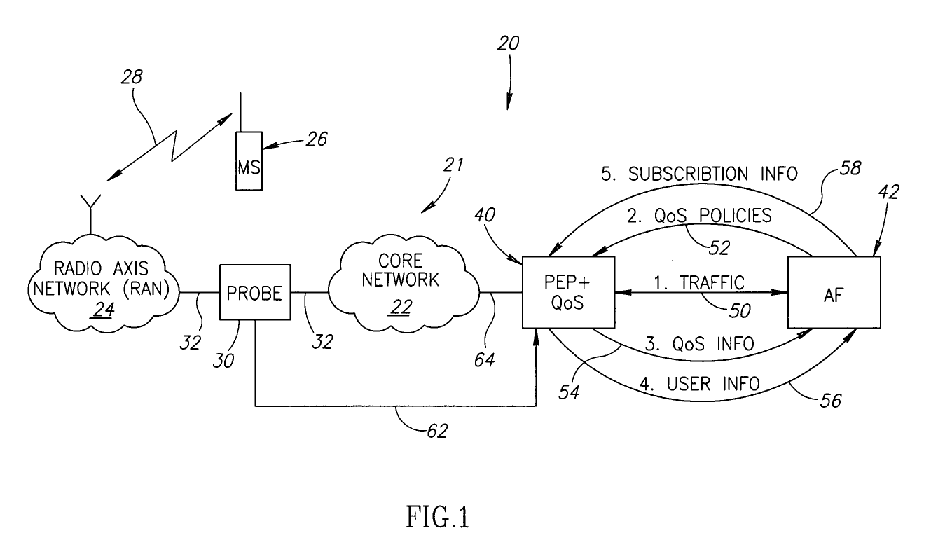

FIG. 1 details an exemplary architecture for a system 20. The system 20 includes a mobile network 21, for example, a General Packet Radio Service (GPRS) network, that may be formed of components including a core network 22 with a radio access network (RAN) 24 that serves (provides services to) mobile stations 26 (one mobile station 26 is shown as exemplary for multiple mobile stations) through air interfaces 28. The mobile station(s) 26 may be, for example, a cellular telephone, or any other device with cellular phone capabilities capable of providing data services (for example, personal digital assitants (PDA), iPAQs, etc.). A probe 30 sits along the core network 22, typically at a Gb interface 32 (an interface between the Serving GPRS support node (SGSN) and the core network 22), and when the RAN is a GPRS/Enhanced General Packet Radio Service (EGPRS) radio access network (GERAN), the Gb interface 32 is in accordance with that described in 3GPP TS 23.060 V3.7.0 (2001-03), 3^{rd} Generation Partnership Project (3GPP); Technical Specification Group Services and Systems Aspects; General Packet Radio Service (GPRS); Service Description; Stage 2 (Release 1999), from 3GPP Organizational Partners, Valbonne France, ©2000 (hereinafter “3GPP TS 23.060”), this document incorporated by reference herein.

The other side of the core network 22 includes an integration device 40 linked by various channels to at least one application function (AF) 42. This application function (AF) 42 is integrated into the mobile network 21.

The integration device 40 may be, for example, a server or other like unit or multiple units, that may be linked to the at least one application function (AF) 42 through physical channels, for example, Wide Area Networks (WANs), Local Area Networks (LANs) or Public Data Networks (PDNs), such as the Internet. Within the physical channels are logical channels 50, 52, 54, 56 and 58, for example, for accommodating traffic 50, Quality of Service (QoS) policies 52, QoS information 54, user information 56 and subscription information 58.

These logical channels 50, 52, 54, 56 and 58, are in accordance with the directions indicated by the respective arrows. Logical traffic channel 50 is bidirectional between the integration device 40 and the application function (AF) 42. Channels for QoS policies 52 and subscription information 58 are typically unidirectional, from the application function (AF) 42 to the integration device 40. Channels for QoS information 54 and user information 56 are typically unidirectional, from the integration device 40 to the application function 42.

The integration device 40 is typically linked to the probe 30 by wired and/or wireless links 62, that are single or multiple. The probe 30 is a measurement or analytic device that is able to extract information from the Gb interface 32, or any other link connection to the radio access network 24 and the core network 22. The data or information extracted by the probe 30 is translated into information describing network topology, connected mobile stations 26, and current radio conditions. The integration device 40 is also linked to the core network 22 through an interface 64. The interface 64 may be a Gi interface (a GPRS interface located between the GGSN (GPRS Gateway Support Node) component of the core network 22 and a public data network (PDN) such as the application function (AF) 42).

Throughout this document there are references to “links”. These links can be single or multiple, and wired or wireless, or combinations thereof.

The core network 22 may be a network, such as that detailed in 3GPP TS 23.060. The interface 32 is typically built upon E1 or Frame Relay lines, and the protocol is, for example, Base Station GPRS Protocol (BSSGP) in accordance with 3GPP TS 08.18 V6.8.0 (2001-06), 3^{rd} Generation Partnership Project (3GPP); Technical Specification Group GSM/EDGE Radio Access Network; General Packet Radio Service (GPRS); Base Station System (BSS)—Serving GPRS Support Node (SGSN); BSS GPRS Protocol (BSSGP) (Release 1997), from 3GPP Organizational Partners, Valbonne France, ©2001 (hereinafter “3GPP TS 08.18”), 3GPP TS 08.18 is incorporated by reference herein, in accordance with the Gb interface definition in 3GPP TS 08.14 V8.0.1 (2002-05), 3 Generation Partnership Project (3GPP); Technical Specification Group GSM/EDGE Radio Access Network; General Packet Radio Service (GPRS); Base Station System (BSS)—Serving GPRS Support Node (SGSN) interface; Gb interface Layer 1 (Release 1999), from 3GPP Organizational Partners, Valbonne France, ©2001 (hereinafter “3GPP TS 08.14”). 3GPP TS 08.14 is incorporated by reference herein.

The application functions (AF) 42 provides services to each mobile station 26, the core network 22 and the radio access network (RAN) 24. Some application functions (AF) 42, for example, include servers or application servers, proxy servers, web servers, streaming servers, performance enhancement proxies and routers.

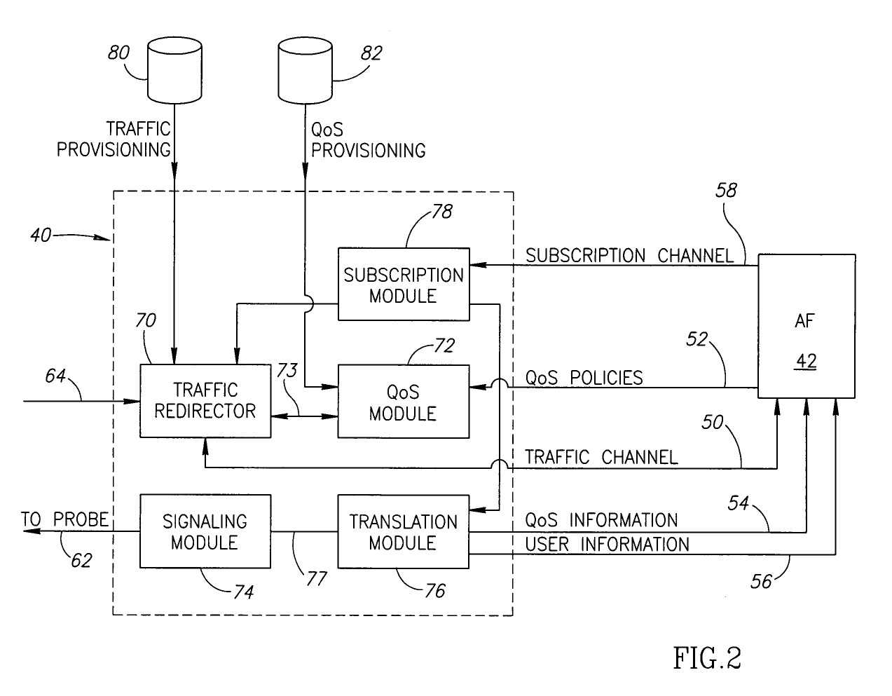

Turning also to FIG. 2, the integration device 40 and the application function (AF) 42 are shown in detail. The integration device 40 includes components that provide high QoS, by obtaining QoS policies and enforcing them. The integration device 40 serves as a Policy Enforcement Point (PEP). The integration device 40 also includes a mechanism for notification of the application function (AF) 42 about currently existing network conditions. The notification mechanism within the integration device 40 is designed to relay information from the radio access network 24 to the application function (AF) 42, with data usable by the application function (AF) 42. The notification mechanism forms part of the functionality of the integration device 40.

The integration device 40 also functions to control traffic, typically packetized, and also provides subscription services. Traffic control involves, for example, controlling traffic movement, redirecting traffic, traffic shaping and traffic analysis. The subscription service included in the integration device 40 is designed to notify the integration device 40 of the type of traffic to be redirected to the application function (AF) 42, and the type of data from the mobile network 21 to be sent to the application function (42).

The control of traffic, for example, in flows of single or multiple packets, may be bidirectional, in both the uplink and downlink directions. These flows may be such that portions of the traffic, or all of the traffic, are controlled in accordance with the network rules and network topology (the manner in which network components and/or elements are connected or linked). Traffic control may include transfer of packets or groups of packets to appropriate directions, redirection of traffic or parts of it, traffic shaping, and traffic analysis.

Redirection of traffic involves changing the original destination of the packet or groups of packets to a new destination. This new destination may be in accordance with data provided by the application function (AF) 42 and/or pre-defined rules or policies. For example, this new destination may be an address of an application function (AF) 42 or group of application functions.

Traffic shaping, for example, may include traffic queuing, prioritization, admission and drop control and the like. Exemplary applications of queuing, prioritization, admission and drop control are detailed in commonly owned Published U.S. Patent Applications, Pub. No. US 2003/0032433 A1, entitled: Resource Management in Cellular Networks, Pub. No. US 2003/0039233 A1, entitled: Estimation of Resources in Cellular Networks, Pub. No. US 2004/0032828 A1, entitled: Service Management in Cellular Networks, Pub. No. US 2004/0033806 A1, entitled: Packet Data Traffic Management System for Mobile Data Networks, Pub. No. US 2004/0203825 A1, entitled: Traffic Control in Cellular Networks, and Pub. No. US 2004/0248583 A1, entitled: Resource Allocation in Cellular Telephone Networks. All six of these Published U.S. Patent Applications are incorporated by reference herein.

Traffic analysis, for example, may include traffic classification on different protocol layers, of protocols, for example, Transmission Control Protocol/Internet Protocol (TCP/IP), Hypertext Transfer Protocol (HTTP), Wireless Application Protocol (WAP), Real Time Streaming Protocol (RTSP), and Real-Time Transport Protocol (RTP).

The integration device 40 is typically formed from multiple components. These components may include a traffic redirector (redirector module) 70 coupled to a QoS module 72 for traffic management. This integration device 40 receives data from the probe 30 through a signaling module 74 (over a link 62) coupled to a translation module 76. Within this integration device 40 is a subscription module 78, linked to the traffic redirector 70 and to the translation module 76. This linkage is designed to transfer data or information between components for controlling the requisite services requested by the Application Function (AF) 42. The integration device 40 can include components, for example, storage media, interfaces and the like, additional to the above listed components, to additionally facilitate its operation.

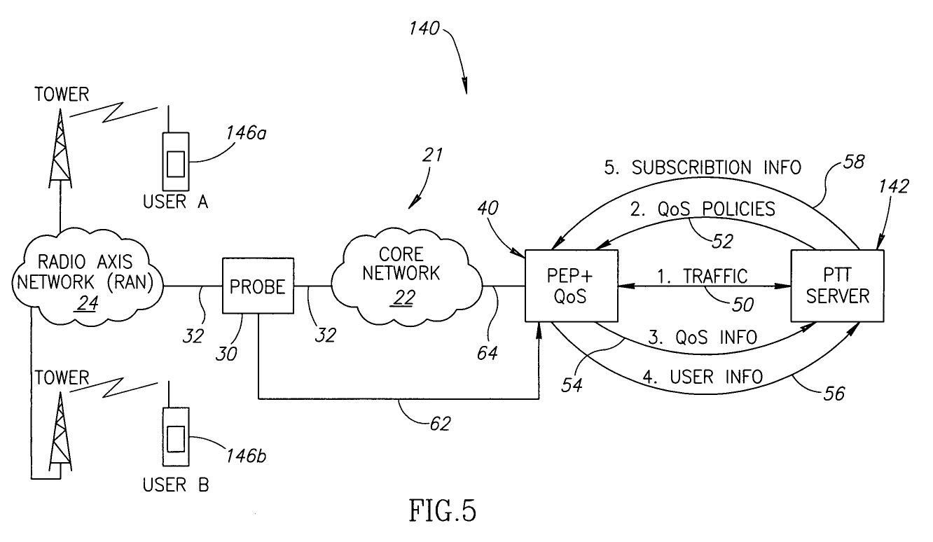

The traffic redirector 70 functions to pass downlink and uplink traffic to the intended destination and to redirect portions of this traffic to the Application Function (AF) 42. For example, if the application function (AF) 42 is a Push To Talk (PTT) server (as shown in FIG. 5 and detailed below), the intended destination is either a PTT server or a sending or a receiving PTT mobile station that supports PTT. The redirected traffic is passed over the traffic channel 50, as well as the traffic that was originally intended for the application function (AF) 42. This redirection is done in accordance with policies received from a traffic provisioning database 80 linked to the traffic redirector 70. This traffic provisioning database 80 includes policies for controlling traffic by the traffic redirector 70, that are dependent on the specific Application Function (AF) 42, and any additional data, such as data that, received as input by a system administrator or the like, into the provisioning database 80. Similarly, the policies are typically programmed into the provisioning database 80 by a system administrator or the like.

Alternately, the traffic redirector 70 can redirect traffic based on information received from the subscription module 78. The traffic redirector 70 is coupled with the QoS module 72 in order that all uplink and downlink traffic from and to the traffic redirector 70 will pass through the QoS module 72 via the link 73 (that is typically bidirectional).

The QoS module 72 enforces QoS policies over the passing traffic or portions of it. Enforcement of QoS policies over this traffic, for example, may include bandwidth allocation (reassignments of bandwidth) among the existing traffic, also known as flows (of packets), prioritization of traffic (or flows), admission of traffic (or flows) into the network, dropping of existing traffic (or flows) from the remaining traffic (or flows). The QoS module 72 receives its policies from either the application function (AF) 42 over a QoS channel 52 or from a QoS provisioning database 82. The QoS policies sent over a QoS channel 52 may, for example, be sent through Diffserv Protocol, as specified in, K. Nichols, et al., Network Working Group Request for Comments (RFC) 2474, Definition of the Differentiated Services Field (DS Field) in the IPv4 and IPv6 Headers, December 1998, ©The Internet Society 1998 (hereinafter “RFC2474) and A. Terzis, et al., Network Working Group Request for Comments (RFC): 2745, RSVP Diagnostic Messages, January 2000, ©The Internet Society 2000 (hereinafter “RFC2745”). RFC2474 and RFC2745 are incorporated by reference herein. Another protocol that may be used to send QoS policies from the application function (AF) 42 is Common Open Policy Service (COPS) as specified in, D. Durham, Ed., et al., Network Working Group Request For Comments (RFC): 2748, The COPS (Common Open Policy Service) Protocol, January 2000, ©The Internet Society 2000 (hereinafter, “RFC2748”), K. Chan, et al., Network Working Group Request for Comments (RFC): 3084, COPS Usage for Policy Provisioning (COPS-PR), March 2001, ©The Internet Society 2001 (hereinafter “RFC3084”) and 3GPP TS 29.207 V6.0.0 (2004-06), 3^{rd} Generation Partnership Project (3GPP); Technical Specification Group Core Network; Policy control over Go interface (Release 6), from 3GPP Organizational Partners, Valbonne France, ©2004 (hereinafter “3GPP TS 29.207”). RFC2748, RFC3084 and 3GPP TS 29.207 are incorporated by reference herein.

The signaling module 74 receives information about all radio conditions and all currently active mobile stations 26 from the probe 30. If the network is a large mobile network, the signaling module 74 would receive this information from multiple probes. This signaling module typically stores and processes this information in order to create a map (summary of the current status) of the currently operational radio access network.

The translation module 76, via the link 77, queries the signaling module 74 for the information that is to be supplied for supporting the application function (AF) 42 (this information is specific to each application function (AF) 42 and is dependent upon the subscription that the application function (AF) 42 made through the subscription module 78, as described below).

The information related to the current radio conditions, such as, available bandwidth, delay and jitter, is sent to the application function (AF) 42 over the QoS information channel 54. All information related to currently connected users and their locations within the mobile network is sent to the Application Function (AF) 42 over the user information channel 56. Both channels 54, 56 may be supported by the DIAMETER Protocol as specified in, F. Calhoun, et al., Network Working Group Request for Comments: 3588, Diameter Base Protocol, September 2003, ©The Internet Society 2003 (hereinafter “RFC3588”). RFC3588 is incorporated by reference herein.

Alternately the QoS information channel 54 and the user information channel 56 may be supported by different protocols. For example, the QoS information channel 54 may be supported by DIAMETER Protocol, while the user information channel 56 may be supported by RADIUS Protocol as specified in, C. Rigney, et al., Network Working Group Request for Comments: 2865, Remote Authentication Dial In User Service (RADIUS), June 2000, ©The Internet Society 2000 (hereinafter “RFC2865”). RFC2865 is incorporated by reference herein.

The subscription module 78 functions to receive subscription requests from the application function (AF) 42, as sent over the subscription channel 58. The data passed over the subscription channel 58 from the application function (AF) 42 may include subscription requests for specific network conditions, specific mobile stations 26, or for specific parts of traffic. This will cause the subscription module 78 to translate the subscription requests to either a traffic redirection policy, to the traffic redirector 70, or to information supplied to the translation module 76. The translation module 76 processes the information it receives from the subscription module 78 and adjusts the information sent to the application function (AF) 42 in accordance with the subscription request.

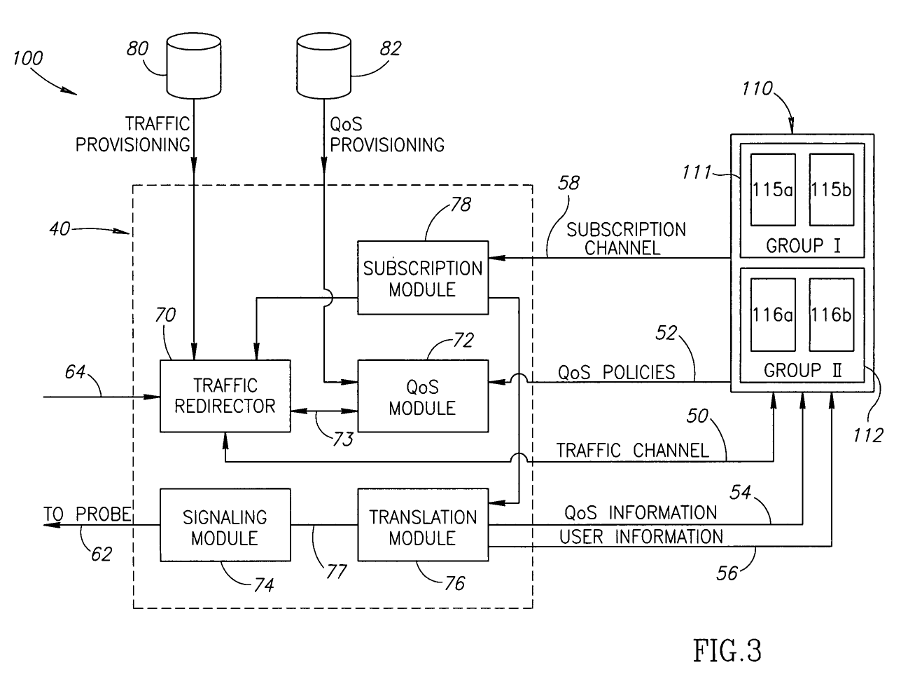

An alternate embodiment of the system 20 is shown by the system 100 in FIG. 3, to which attention is now directed. The system 100 includes all components of system 20 that are numbered similarly and described above. Components specific to this alternate system 100 are detailed below.

The system 100 differs from the system 20 in that the single application function (AF) 42 is replaced by groups of application functions 110. These groups are illustrated by group I, 111 and group II, 112, but could include an arbitrary number of groups of application functions. Each group of application functions 111, 112 may include an arbitrary number of application functions. Here, for example, there are four application functions 115a, 115b of group I, and 116a and 116b for group II, two in each group. While numerous applications of groups of application functions are permissible, this arrangement of application functions is an example of a group of application functions, for explaining the system 100.

In this system 100, the traffic redirector 70 is capable of redirecting traffic separately to each group of Application Functions 111, 112. Each group of application functions 111, 112 contains applications functions (AF) that provide the same or similar services. The redirected traffic may be addressed to all application functions in each group of application functions, or alternately it may be addressed to a single application function within a specific group of application functions. When multiple application functions are addressed by the traffic redirector 70, a broadcast or multicast mechanism may be employed.

The grouped application functions 110 typically require load balancing, by the traffic redirector 70, in order to reduce traffic load on a single application function. The traffic redirector 70 may implement a load balancing policy when redirecting traffic to a particular group of application functions. The load balancing policy, for example, may be accomplished by distributing connections among all application functions 115a and 115b, 116a and 116b, within the specific group 111, 112 of application functions by employing different distribution algorithms, for example, round-robin.

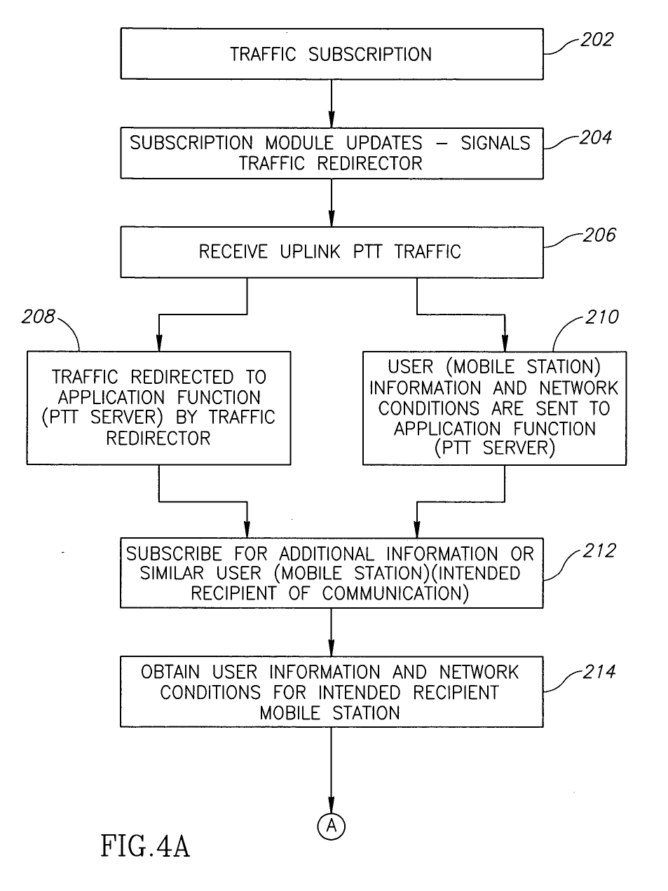

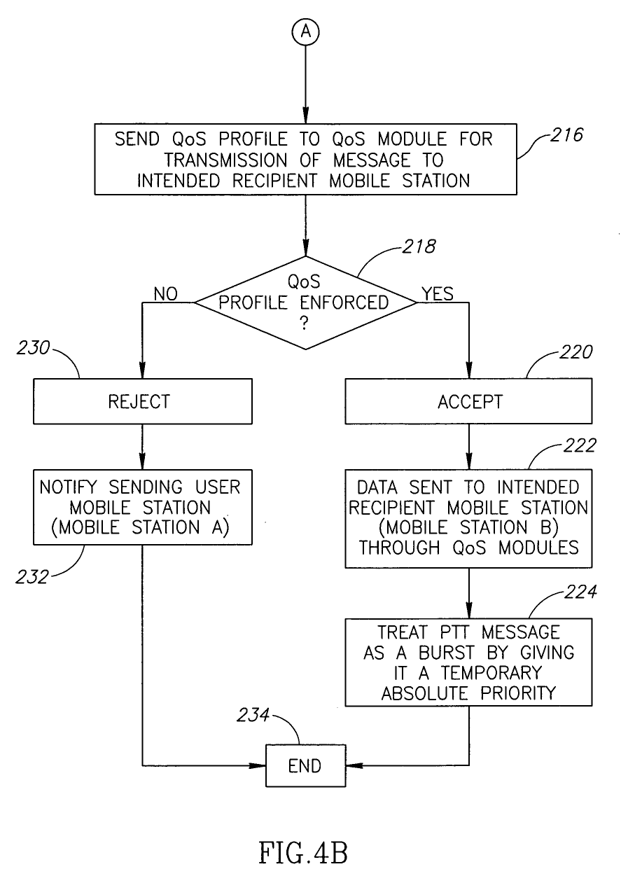

FIGS. 4A and 4B form a flow diagram detailing an exemplary operation of an exemplary system 140 and its architecture, as shown in FIG. 5, to which attention is now also directed. The system 140 incorporates a Push To Talk (PTT) application function into a mobile network 21. The system 140 of FIG. 5 is similar to system 20 of FIGS. 1 and 2, except that the application function (AF) is, for example, a Push To Talk (PTT) server 142. Accordingly, components in FIG. 5 with corresponding numerals and/or characters, to those components of FIGS. 1 and 2, are similar to the respective components of FIGS. 1 and 2, and have been described above.

The PTT server 142 provides PTT services to mobile stations 146a and 146b (representative of the multiple mobile stations of a mobile network, and similar to the mobile stations 26 detailed above), corresponding to mobile station(s) associated with two different users, user A, designated as mobile station A 146a, and user B, designated as mobile station B 146b. Both mobile station A 146a and mobile station B 146b are serviced by the radio access network (RAN) 24.

PTT, as used here, is a voice message communication service that allows two or more mobile stations to exchange voice messages in real-time. The PTT voice communication is unidirectional (half-duplex). Message delivery is almost instantaneous.

PTT as described herein also includes digital services over Third Generation (3G) data networks, for example, PTT over Cellular (PoC), such as described in, 3GPP TR 23.979 V2.0.0 (2004-11), 3^{rd} Generation Partnership Project (3GPP); Technical Specification Group Services and System Aspects; 3GPP enablers for OMA PoC Services; Stage 2 (Release 6), from 3GPP Organizational Partners, Valbonne France, ©2003 (hereinafter “3GPP TR 23.979 V2.0.0”) (and portions of the document, 3GPP TR 23.979 V0.6.0 (2004-05), 3^{rd} Generation Partnership Project (3GPP); Technical Specification Group Services and System Aspects; 3GPP enablers for OMA PoC Services; Stage 2 (Release 6), from 3GPP Organizational Partners, Valbonne France, ©2003 (hereinafter “3GPP TR 23.979 V0.6.0”), that are identical and/or consistent with corresponding portions of 3GPP TR 23.979 V2.0.0.) 3GPP TR 23.979 V0.2.0 and 3GPP TR 23.979 V0.6.0 are incorporated by reference herein.

PTT service requires typically requires a specific minimal amount of bandwidth and low delay. PTT voice messages typically are of a few packets, for example, less than 30 packets. These packets that form a single PTT voice message typically travel as a single short sequence of packets. In order to provide PTT service with good QoS and QoE, the PTT server may be integrated within the mobile network 21, similar to that shown in FIG. 2 (where the application function (AF) 42 is the PTT server 142 in FIG. 5).

In describing the process, reference is made to two mobile stations 146a, 146b. A first mobile station that initiates the PTT communication (the “sending” mobile station) is designated mobile station A 146a, while a second mobile station, to which the PTT communication is intended (the “intended recipient” mobile station), is designated as mobile station B 146b. While communication between two mobile stations 146a, 146b is discussed here, this is exemplary only, and may be expanded to multiple mobile stations.

The process of PTT in the mobile network begins by initiating a traffic subscription at block 202. During this stage, the PTT server connects to the integration device 40 through the subscription channel 58, and notifies the subscription module 78 about the type of traffic it is capable of receiving. The traffic type definition may include protocol types, port numbers, protocol fields (from different layers) and other characteristics.

The subscription module 78 is updated, and signals the traffic redirector 70 (traffic redirector) at block 204. This update typically includes translating the received traffic information into a traffic profile designed for the traffic redirector (redirector module) 70. At this point in time, the network may not have PTT subscribers, either connected or active.

The process moves to block 206 when the uplink (from the mobile station 146a to the traffic redirector 70) PTT traffic, from one of the mobile stations 146a is received.

The process now moves to blocks 208 and 210, where the processes therein are typically performed in parallel, or contemporaneous with each other. At block 208, the uplink traffic (the burst of packets) is redirected to the PTT server 142 (the application function (AF)) through the traffic channel 50, in accordance with the traffic policies that were obtained by the traffic redirector 70 at block 204 above.

At block 210, the translation module 76 obtains information about the mobile station 146a that initiated the PTT voice message, from the signaling module 74. Here, mobile station A 146a initiated the PTT message. The translation module 76 translates the obtained information into data usable by the PTT server 142, and sends it to the PTT server 142 through the user information channel 56. The data sent by the translation module 76 may include user identifications, for example, International Mobile Station Identity (IMSI), International Mobile station Equipment Identity (IMEI), Mobile Station International Integrated Services Digital Network (MSISDN), the aforementioned three acronyms as described in, 3GPP TS 03.03 V7.8.0 (2003-09), 3^{rd} Generation Partnership Project (3GPP); Technical Specification Group Core Network; Numbering, addressing and identification; (Release 1998), from 3GPP Organizational Partners, Valbonne France, ©2003 (hereinafter “3GPP TS 03.03”), this document incorporated by reference herein, and radio network conditions, for example, available bandwidth and delay.

The process moves to block 212, where the application function (AF) 42 subscribes for information for the intended recipient of the PTT communication, here, Mobile Station B 146b. The sub-process of block 212 is accomplished as follows. The application function (AF) 42 determines the identification of another mobile station, here, for example, mobile station B 146b. This identification may be obtained from the incoming PTT message. The identification is, for example, an Internet Protocol (IP) address, or a unique character string assigned to a mobile user by the PTT system. This character string could be, for example, a name, a phrase, a nickname or the like. Based on the obtained user identity, the application function (AF) 42 sends a subscription request to the subscription module 78 through the subscription channel 58. The subscription request serves to request the integration device 40 to supply the application function (AF) 42 with the information about the Mobile Station B 146b.

The process moves to block 214 where user information and network for the intended mobile station, here, Mobile Station B 146b, are obtained. This is accomplished, for example, as the subscription request is forwarded from the subscription module 78 to the translation module 76. The translation module 76 obtains information about the Mobile Station B 146b, that is the recipient of the PTT voice message from the signaling module 74. The translation module 76 translates the obtained information into data usable by the PTT server 142, and sends it to the PTT server 142 through the user information channel 56. The data sent by the translation module 76 may include user identification, for example, International Mobile Station Identity (IMSI), International Mobile station Equipment Identity (IMEI), Mobile Station International Integrated Services Digital Network (MSISDN), the aforementioned three acronyms as described in 3GPP TS 03.03, and radio network conditions, for example, available bandwidth and delay, in a manner similar to that for block 210 described above.

At block 216, the application function (AF) 42 sends a QoS profile to the QoS module 72 through the QoS channel 52. This QoS profile will indicate that the message to be transmitted is a PTT message and will define conditions desired for the best transmission of PTT voice messages to the intended recipient of a PTT voice communication, here, Mobile Station B 146b. Typically, the QoS profile includes data indicating that the PTT message to be sent by the PTT server (to the intended recipient of a PTT voice communication) will be a burst. A burst occurs as a specific amount of data is sent or received in one intermittent operation.

Optionally, this QoS profile can include additional information about a burst, such as, burst size, or burst spacing. In accordance with aforementioned PTT communications, burst size may be the maximum number of continuous bytes to be regarded as burst, and burst spacing is the maximal interval between two packets that belong to the same burst.

The process moves to block 218, where the QoS module 72 checks if the QoS profile received from the application function (AF), here the PTT Server 142, at block 216, can be enforced. If the mobile network has all the resources to satisfy all conditions specified by the QoS profile, the QoS profile is accepted, and therefore, enforced, at block 220. At block 220, the QoS module 72, having accepted the QoS profile, sends an acceptance response (data corresponding to an acceptance) to the PTT server 142.

Alternately, if the QoS module 72 does not have all the information about resources available for Mobile Station B 146b or the cell where Mobile Station B 146b is located, the QoS module 72 may decide to send an acceptance response to the PTT server 142. A decision made by the QoS module 72 in this manner, without all the resource availability information for the intended mobile station, is known as a “fast admission”.

With an acceptance response sent to the PTT server 142 by a normal communication or a “fast admission”, the process now moves to block 222. The PTT server 142 begins sending the PTT voice message to the intended recipient of the PTT communication, here, Mobile Station B 146b, through the QoS module 72.

At block 224, the QoS module 72 starts to receive a PTT voice message from the PTT server 142. According to the QoS policy, active in the QoS module 72 for this particular PTT transmission, the QoS module 72 may decide to temporarily stop transmitting packets for other communications destined for the same cell or mobile station as this particular PTT voice message. For example, this may be done by revoking allocated bandwidth from currently existing traffic. In doing so, the QoS module 72 will give temporary absolute priority for the PTT voice messages, by treating them as a burst. The QoS module 72 returns to its normal operational mode of assigning priorities either instantaneously, after the PTT voice message is completely transmitted, or at a pre-determined (pre-programmed) time interval (for example, on the order of seconds). With the PTT voice messages transmitted and QoS module 72 having returned to normal operation, the process moves to block 234.

Turning back to block 218, alternately, if the mobile network lacks sufficient resources to satisfy all conditions specified by the QoS profile, the process moves to block 230. The QoS policy is not enforced. At block 230 the QoS module 72 rejects the QoS profile, and sends a reject response to the application function (AF), here, the PTT Server 142, through the QoS policy channel 52. Upon reception of reject response from the QoS module, at block 232, the application function (AF), here, the PTT Server 142, sends a notification response to the initiating mobile station, here, Mobile Station A 146a. This response notifies Mobile Station A 146a that the PTT voice message can not be delivered to the intended recipient (Mobile Station B 146b).

The process ends at block 234, from blocks 224 and 232. Subsequent PTT requests are also processed in accordance with this exemplary operation. This exemplary operation can be repeated for as long as desired in accordance with the number of PTT requests to be processed.

The above described processes including portions thereof can be performed by software, hardware and combinations thereof. These processes and portions thereof can be performed by computers, computer-type devices, workstations, processors, micro-processors, other electronic searching tools and memory and other storage-type devices associated therewith. The processes and portions thereof can also be embodied in programmable storage devices, for example, compact discs (CDs) or other discs including magnetic, optical, etc., readable by a machine or the like, or other computer usable storage media, including magnetic, optical, or semiconductor storage, or other source of electronic signals.

The processes (methods) and systems, including components thereof, herein have been described with exemplary reference to specific hardware and software. The processes (methods) have been described as exemplary, whereby specific steps and their order can be omitted and/or changed by persons of ordinary skill in the art to reduce these embodiments to practice without undue experimentation. The processes (methods) and systems have been described in a manner sufficient to enable persons of ordinary skill in the art to readily adapt other hardware and software as may be needed to reduce any of the embodiments to practice without undue experimentation and using conventional techniques.

While preferred embodiments of the present invention have been described, so as to enable one of skill in the art to practice the present invention, the preceding description is intended to be exemplary only. It should not be used to limit the scope of the invention, which should be determined by reference to the following claims.

What is claimed is:

1. An architecture for supporting at least one application function, comprising:
a first component for obtaining information on conditions in a mobile network;
a second component for receiving and translating the information on the conditions in the mobile network to data usable by the at least one application function, and sending the information to the at least one application function;
a traffic control module configured for controlling traffic to and from the at least one application function; and,
a Quality of Service (QoS) module configured for receiving Quality of Service policies and enforcing the Quality of Service policies on the traffic to and from the at least one application function.

2. The architecture of claim 1, wherein the Quality of Service module is additionally configured for receiving Quality of Service policies from a Quality of Service provisioning database and from the at least one application function.

3. The architecture of claim 1, wherein the Quality of Service module configured for enforcing the received QoS policies, enforces the QoS policies based on the information inside the policies and on the information on conditions in the mobile network.

4. The architecture of claim 2, wherein the Quality of Service policies sent by the at least one application function to the Quality of Service module are dependent on the information on conditions in the mobile network.

5. The architecture of claim 1, wherein the first component includes at least one probe for receiving data from at least one interface or link.

6. The architecture of claim 1, wherein the traffic control module includes a traffic redirecting module.

7. The architecture of claim 6, wherein the traffic control module is configured for receiving traffic policies from a traffic policy provisioning system and from the at least one application function.

8. The architecture of claim 1, additionally comprising a subscription module, configured for receiving at least one subscription request from the at least one application function, and translating the at least one subscription request to a traffic policy for the traffic control module or policies for the second component.

9. The architecture of claim 1, wherein the information on conditions in a mobile network is selected from the group consisted of network topology, user locations, available network capacity and Quality of Service (QoS) parameters.

10. The architecture of claim 9, wherein the Quality of Service (QoS) parameters are selected from the group consisting of delay and jitter.

11. The architecture of claim 1, wherein the at least one application function is selected from the group consisting of: servers, application servers, proxy servers, web servers, streaming servers, performance enhancement proxies, routers, and, Push To Talk (PTT) servers.

12. The architecture of claim 1, wherein the at least one application function includes a single application function.

13. The architecture of claim 1, wherein the at least one application function includes a plurality of application functions.

14. A method for managing traffic for at least one application function, comprising:
obtaining information on conditions in a mobile network;
translating the obtained information on the conditions in the mobile network to data usable by the at least one application function;
sending the translated information to the at least one application function in accordance with at least one predetermined policy; and,
controlling traffic to and from the at least one application function by enforcing the at least one predetermined policy on the traffic to and from the at least one application function.

15. The method of claim 14, additionally comprising: receiving Quality of Service (QoS) policies from a Quality of Service provisioning database and from the at least one Application Function.

16. The method of claim 14, additionally comprising: enforcing the received Quality of Service (QoS) policies based on the information inside the policies and on the information on conditions in the mobile network.

17. The method of claim 14, wherein the at least one application function is selected from the group consisting of: servers, application servers, proxy servers, web servers, streaming servers, performance enhancement proxies, routers and Push To Talk (PTT) servers.

18. An architecture for supporting at least one application function, comprising:
a first component for obtaining information on conditions in a mobile network;
a second component for receiving and translating the information on the conditions in the mobile network to data usable by the at least one application function, and sending the information to the at least one application function;
a traffic control module configured for controlling traffic to and from the at least one application function; and,
a subscription module, configured for receiving at least one subscription request from the at least one application function, and translating the at least one subscription request to at least one traffic policy for at least one of: the traffic control module or the second component.

19. The architecture of claim 18, additionally comprising: a Quality of Service (QoS) module configured for receiving Quality of Service (QoS) policies and enforcing these policies on the traffic to and from the at least one application function.

20. The architecture of claim 18, wherein the Quality of Service (QoS) module is additionally configured for receiving Quality of Service (QoS) policies from a Quality of Service (QoS) provisioning system and from the at least one application function.

21. The architecture of claim 18, wherein the Quality of Service (QoS) module is configured for enforcing the received Quality of Service (QoS) policies based on the information inside the policies and on the information on conditions in the mobile network.

22. The architecture of claim 19, wherein the Quality of Service (QoS) policies sent by the at least one application function to the Quality of Service (QoS) module are dependent on the information on conditions in the mobile network.

23. The architecture of claim 18, wherein the first component includes at least one probe for receiving data from at least one interface or link.

24. The architecture of claim 18, wherein the traffic control module includes a traffic redirecting module.

25. The architecture of claim 24, wherein the traffic control module is configured for receiving traffic policies from a traffic policy provisioning system and from the at least one application function.

26. The architecture of claim 18, wherein the information on conditions in a mobile network is selected from the group consisted of network topology, user locations, available network capacity and Quality of Service (QoS) parameters.

27. The architecture of claim 26, wherein the Quality of Service (QoS) parameters are selected from the group consisting of delay and jitter.

28. The architecture of claim 18, wherein the at least one application function is selected from the group consisting of: servers, application servers, proxy servers, web servers, streaming servers, performance enhancement proxies, routers and Push To Talk (PTT) servers.

29. A method for integrating at least one application function into a mobile network, comprising:
obtaining information on conditions in a mobile network;
translating the information on the conditions in a mobile network to data usable by the at least one application function, and sending the information to the at least one application function;
controlling traffic to and from the at least one application function;
receiving at least one subscription request from the at least one application function; and,
translating the at least one subscription request to at least one of:
a traffic policy for controlling traffic to and from the at least one application function; or
at least one policy for translation of information on conditions in the mobile network.

30. The method of claim 29, additionally comprising: receiving Quality of Service (QoS) policies from a Quality of Service (QoS) provisioning database and from the at least one application function.

31. The method of claim 30, additionally comprising: enforcing the received Quality of Service (QoS) policies based on the information inside the policies and on the information on conditions in the mobile network.

32. The method of claim 29, wherein the at least one application function is selected from the group consisting of: servers, application servers, proxy servers, web servers, streaming servers, performance enhancement proxies, routers and Push To Talk (PTT) servers.

33. An architecture for supporting Push To Talk (PTT) services in a network, comprising
a first component configured for controlling PTT traffic, between at least one mobile station and at least one application function;
a second component for receiving and translating information on conditions in a network to data usable by the first component; and,
a third component configured for accommodating bursts corresponding to PTT traffic by temporarily revoking bandwidth from other traffic and admitting the PTT traffic into the network regardless of receiving information on the network conditions.

34. The architecture of claim 33, wherein the network includes a mobile network.

35. The architecture of claim 33, where the at least one application function includes at least one Push To Talk (PTT) server.

36. The architecture of claim 33, additionally comprising: at least one mobile station.

37. The architecture of claim 33, wherein the first component and the third component define a portion of a Quality of Service (QoS) module.

38. The architecture of claim 37, where the Quality of Service (QoS) module is additionally configured to perform at least one of the group consisting of: bandwidth allocation, traffic prioritization, admission of traffic into the network, and dropping of existing traffic from the network.

39. The architecture of claim 33, additionally comprising: a traffic redirector configured for controlling traffic to and from the at least one application function.

40. The architecture of claim 39, wherein the traffic redirector is configured for receiving traffic policies from a traffic policy provisioning system and from the at least one application function.

41. The architecture of claim 40, additionally comprising: a subscription module, configured for receiving at least one subscription request from the at least one application function, and for translating the at least one subscription request to a traffic policy for the traffic redirector.

42. The architecture of claim 33, additionally comprising: a subscription module, configured for receiving at least one subscription request from the at least one application function, and translating the at least one subscription request to a policy for the second component.

43. A method for supporting Push To Talk (PTT) services in a network, comprising:
controlling Push To Talk (PTT) traffic, between at least one mobile station and at least one application function;
receiving and translating information on conditions in a network to data usable for control of the Push To Talk (PTT) traffic; and,
accommodating bursts corresponding to the Push To Talk (PTT) traffic by temporarily revoking bandwidth from other traffic and admitting the Push To Talk (PTT) traffic into the network.

44. The method of claim 43, wherein admitting the Push To Talk (PTT) traffic into the network includes admission regardless of receiving information on conditions of the network.

45. The method of claim 43, wherein controlling the Push To Talk (PTT) traffic includes controlling Quality of Service (QoS) parameters associated with the Push To Talk (PTT) traffic.

46. The method have claim 45, wherein controlling the Quality of Service (QoS) parameters includes controlling one of the parameters selected from the group consisting of: bandwidth allocation, traffic prioritization, admission of traffic into the network and drop of existing traffic.

47. The method of claim 43, additionally comprising: receiving traffic policies from a traffic policy provisioning system and from at least one application function, and applying these policies to the Push To Talk (PTT) traffic.

48. The method of claim 43, additionally comprising: receiving at least one subscription request from the at least one application function, and translating the at least one subscription request to a policy for translation of information on the network conditions.

49. The method of claim 43, additionally comprising: receiving at least one subscription request from the at least one application function, and translating the at least one subscription request to a traffic policy for redirecting the Push To Talk (PTT) traffic.
